(19) United States
(12) Patent Application Publication
(10) Pub. No.: US 2012/0098450 A1
(43) Pub. Date: Apr. 26, 2012

(54) LIGHTING DEVICE AND ILLUMINATION APPARATUS USING SAME

(75) Inventors: Sana Esaki, Ibaraki (JP); Akinori Hiramatu, Nara (JP)

(73) Assignee: Panasonic Electric Works Co., Ltd., Osaka (JP)

(21) Appl. No.: 13/277,540

(22) Filed: Oct. 20, 2011

(30) Foreign Application Priority Data
Oct. 25, 2010 (JP) 2010-238401

(51) Int. Cl. H05B 37/02

(52) U.S. Cl. 315/209 R

(57) ABSTRACT

There is provided a lighting device usable in a space together with 3D glasses having shutters which alternately block respective translucent surfaces of a pair of lenses at one of a plurality of shutter frequencies. The lighting device includes: a lighting unit which outputs a direct current to a light source; and a dimming control unit which turns on/off supply of the direct current to the light source at a predetermined PWM frequency. Further, the PWM frequency is an integer multiple of the least common multiple of the plurality of shutter frequencies.

### FIELD OF THE INVENTION

The present invention relates to a lighting device and an illumination apparatus using the same.

### BACKGROUND OF THE INVENTION

Conventionally, there is known a lighting device using light emitting diodes (LEDs) as a light source. In order to control the LED brightness, the conventional lighting device performs PWM dimming control in which a current flowing in the LED intermittently stops at a low frequency within a range from about 100 Hz to several kHz, or an amplitude of the LED current changes. In the PWM dimming control, brightness of the LED is controlled by changing a time period (on duty) for supplying the LED with a current by using a PWM signal, and controlling an average value of an optical power (LED current). In the amplitude dimming control, brightness of the LED is controlled by changing a magnitude (amplitude) of the LED current, and controlling an average value of the optical power (LED current).

Further, there is known an LED dimming apparatus in which the amplitude dimming is performed in a case where a level of brightness of the LED is high, and the PWM dimming is performed in a case where the level of the brightness of the LED is low (see, e.g., Japanese Patent Application Publication No. 2009-123681).

When the PWM dimming control is performed by using the PWM signal, it is preferable to set the frequency of the PWM signal (PWM frequency) to be equal to or greater than 100 Hz in order to suppress flickering of the LED. By setting the PWM frequency to be equal to or greater than 100 Hz, human eyes cannot notice the flickering under the LED illumination.

However, when the PWM frequency is set to be equal to or greater than 2 kHz, an on/off time interval is reduced in a region having a high illumination level. Accordingly, it becomes difficult to exactly control the number of ON pulses of the switching device, and the number of ON pulses is dispersedly changed, which leads to reduction in the resolution of the dimming. Further, a noise occurs due to a transformer or the like. For that reason, when the PWM dimming control is performed, it is preferable to set the PWM frequency ranging from 100 Hz to 2 kHZ.

The lighting device performing a PWM dimming control may be applied to an indoor illumination or outdoor illumination at night, and an apparatus for displaying a three-dimensional (3D) image (stereoscopic image), e.g., a 3D television, may be provided within a range illuminated by the illumination. In this case, when a user puts on 3D glasses to watch the 3D image, there is a problem in which a flicker occurs in the user's field of vision.

The basic principle for showing 3D images is to make and present images separately for left and right eyes having a predetermined parallax therebetween such that a viewer can perceive depth and dimensionality of the 3D images by combining the images in his/her own brain.

For example, the 3D television employs a frame sequential method in which an image for the left eye and an image for the right eye are alternately displayed frame by frame. Specifically, 3D glasses include a pair of lenses for right and left eyes, and shutters which block a translucent surface of each lens. Thus, when an image for the left eye is displayed, the shutter of the 3D glasses operates to obstruct the vision of the right eye such that the viewer can only watch by the left eye.

On the contrary to this, when an image for the right eye is displayed, the shutter of the 3D glasses operates to obstruct the vision of the left eye such that the viewer can watch only by the right eye. In this way, it is possible to make the depth and dimensionality of the image recognized by the user by synchronizing a timing of switching frames of the 3D image with a timing of opening and closing the left and right shutters of the 3D glasses by using an infrared signal or the like.

In the 3D television, the number of frames of an image displayed for one second is 60 frames (60 Hz) for each of the left and right eyes such that 120 frames are displayed in total. Further, the shutter speed (shutter frequency) at which the left and right shutters of the 3D glasses are alternately opened and closed is 25 Hz, 30 Hz, 60 Hz or the like, which varies depending on a type of the apparatus or regions.

When a PWM signal having a PWM frequency of, e.g., 100 Hz, is used in the PWM dimming control of a light source, the light source is turned on and off at 100 Hz. In this case, when the shutters of the 3D glasses are repeatedly opened and closed at, e.g., 60 Hz (total 120 times=120 Hz for one second), it is impossible to synchronize the PWM frequency with the shutter speed. That is, a timing of turning on/off the light source does not coincide with a timing of opening/closing the shutter, which causes the user wearing the 3D glasses to perceive a flicker.

Further, it has been known through experiments that a flicker is perceived by a user even when a frequency component of the PWM frequency included in output light (output current) is a few % or less, i.e., even when the light source is controlled to turn on almost all of the LEDs, during the PWM dimming control.

Furthermore, since the shutter frequency varies depending on a type of the apparatus or regions, the PWM frequency at which a flicker occurs is different. Therefore, it is necessary to appropriately set the PWM frequency in consideration of the type and region.

### SUMMARY OF THE INVENTION

In view of the above, the present invention provides a lighting device and an illumination apparatus using the lighting device, which are available for a plurality of pairs of 3D glasses having different shutter frequencies, and capable of preventing a flicker when a user puts on the 3D glasses.

In accordance with an aspect of the present invention, there is provided a lighting device used in a space together with a 3D glasses having shutters which alternately block respective translucent surfaces of a pair of lenses at one of a plurality of shutter frequencies, the lighting device including: a lighting unit which outputs a direct current to a light source; and a dimming control unit which turns on and off supply of the direct current to the light source at a predetermined PWM frequency, wherein the PWM frequency is the product of an integer and the least common multiple of the plurality of the shutter frequencies.

In the lighting device, preferably, the PWM frequency is the product of an even number and the least common multiple.

Further, the lighting device may include a timing synchronizer which synchronizes a timing of turning on/off the supply of the direct current to the light source with a timing of opening/closing the shutters of the lenses of the 3D glasses.

In accordance with another aspect of the present invention, there is provided an illumination apparatus including: a lighting device used in a space together with a 3D glasses having shutters which alternately block respective translucent surfaces of a pair of lenses at one of a plurality of shutter frequencies, the lighting device including a lighting unit which outputs direct current to a light source, and an illumination unit which turns on/off supply of the direct current to the light source at a predetermined PWM frequency, wherein the PWM frequency is the product of an integer and the least common multiple of the plurality of shutter frequencies; and a light source which is turned on by the direct current outputted by the lighting device.

With the above configuration, it is possible to provide a lighting device and an illumination apparatus available for a plurality of pairs of 3D glasses having different shutter frequencies, and capable of preventing a flicker when the user puts on the 3D glasses.

### BRIEF DESCRIPTION OF THE DRAWINGS

Objects and features of the present invention will become apparent from the following description of embodiments, given in conjunction with the accompanying drawings, in which:

FIG. 1 illustrates a circuit configuration of a lighting device in accordance with a first embodiment of the present invention;

FIG. 2 is a block diagram showing an inner configuration of an integrated circuit for control;

FIG. 3 represents waveform diagrams of an LED current and a PWM signal;

FIG. 4 illustrates another example of waveform diagrams of the LED current and the PWM signal;

FIG. 5 is a perspective view schematically showing an external appearance of 3D glasses; and

FIG. 6 schematically depicts a configuration of an illumination apparatus in accordance with a second embodiment of the present invention.

### DETAILED DESCRIPTION OF THE EMBODIMENTS

Hereinafter, embodiments of the present invention will be described with reference to the accompanying drawings which form a part hereof.

### First Embodiment

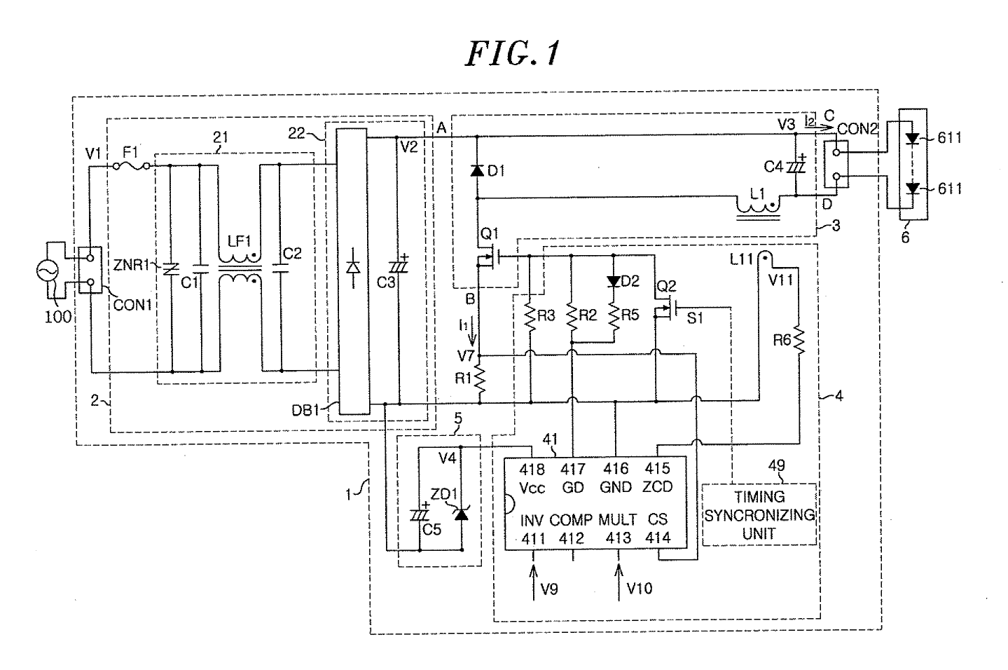

FIG. 1 illustrates a circuit configuration of a lighting device 1 in accordance with a first embodiment of the present invention.

The lighting device 1 of this embodiment includes a power circuit 2, a step-down chopper circuit 3, a control circuit 4 and a control power circuit 5. Further, the step-down chopper circuit 3 corresponds to a lighting unit of the present invention, and the control circuit 4 corresponds to a dimming control unit of the present invention.

The lighting device 1 is supplied with power from a commercial power source 100 (e.g., 100 V, 50/60 Hz) via a connector CON1. The power circuit 2 converts an alternating current (AC) voltage V1 into a rectified voltage V2. Further, the step-down chopper circuit 3 is connected to a light source 6 via a connector CON2. The light source 6 of the embodiment includes one or a plurality of semiconductor light emitting elements (LED elements) 61.

Further, the light source 6 may include an LED module having a plurality of LED elements 61 connected to each other by serial, parallel, or mixed connection. Further, although the LED elements 61 are used as semiconductor light emitting elements in this embodiment, organic electroluminescence (EL) devices or semiconductor laser devices may be used.

Further, the control circuit (dimming control unit) 4 may control dimming of the light source 6 by changing an output current of the step-down chopper circuit 3 based on a PWM signal S1.

Hereinafter, a detailed configuration of each unit will be described.

The power circuit 2 includes a fuse F1, a filter circuit 21, and a rectifying and smoothing circuit 22.

The filter circuit 21 is supplied with an AC voltage V1 from the commercial power source 100 via the connector CON1 and the fuse F1. The filter circuit 21 includes a surge voltage absorber ZNR1, capacitors C1 and C2, and a common mode choke coil LF1 to remove a noise in the AC voltage V1 supplied from the commercial power source 100.

The rectifying and smoothing circuit 22 includes a full-wave rectifier circuit DB1 and a smoothing capacitor C3 to rectify and smooth the AC voltage V1, thereby generating a rectified voltage V2 between both terminals of the smoothing capacitor C3. The rectifying and smoothing circuit 22 may include a power factor improving circuit using a step-up chopper circuit.

Further, since the power circuit 2 has a conventional well-known circuit configuration, a detailed description thereof is omitted.

Next, the step-down chopper circuit 3 will be described.

The step-down chopper circuit 3 includes an inductor L1, a switching device Q1 having an n-channel MOSFET, a diode D1 and a capacitor C4 of an electrolytic capacitor. A series circuit having the capacitor C4, the inductor L1, the switching device Q1 and a resistor R1 is connected between output terminals of the rectifying and smoothing circuit 22. The diode D1 is connected in parallel to the capacitor C4 and the inductor L1.

Further, the light source 6 is connected to both terminals of the capacitor C4 with a connector CON2 interposed therebetween.

When the switching device Q1 is turned on, a direct current I1 flows through the capacitor C4 from the rectifying and smoothing circuit 22, and the capacitor C4 is charged. When the switching device Q1 is turned off, the direct current I1 ceases to flow through the capacitor C4, and the capacitor C4 discharges.

As described above, the switching device Q1 is turned on and off alternately and the capacitor C4 charges and discharges repeatedly. Accordingly, the rectified voltage V2 is stepped down, and a capacitor voltage V3 is generated between both terminals of the capacitor C4. Further, an LED current I2 is supplied to the light source 6 by using the capacitor voltage V3 as a power source.

The control circuit 4 controls the LED current I2 by turning on or off the switching device Q1, thereby controlling the dimming of the light source 6. The control circuit 4 includes an integrated circuit 41 for control and a peripheral circuit thereof.

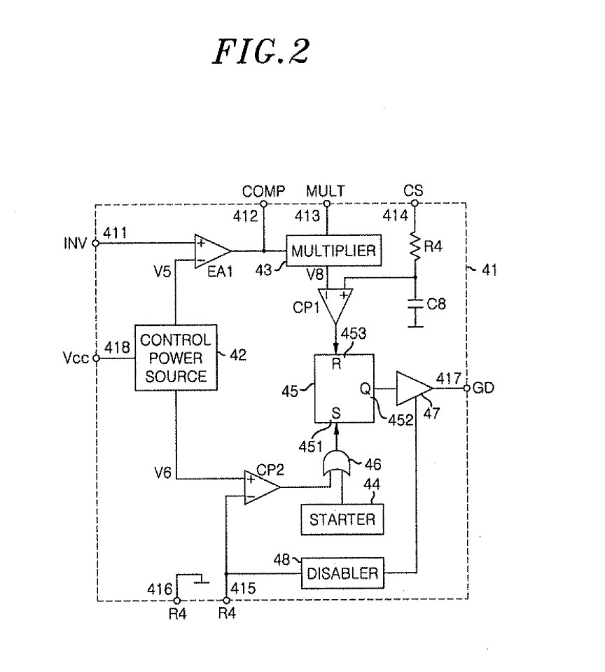

FIG. 2 illustrates an inner configuration of the integrated circuit 41 for control.

An INV pin 411 is connected to an inverting input terminal of an error amplifier (error AMP) EA1. A COMP pin 412 is connected to an output terminal of the error amplifier EA1. A MULT pin 413 is connected to an input terminal of a multiplier circuit 43. A CS pin 414 functions as a chopper current detection terminal. A ZCD pin 415 functions as a zero-cross detection terminal. A GND pin 416 functions as a ground terminal. A GD pin 417 functions as a gate drive terminal. A Vcc pin 418 functions as a power terminal.

When a control voltage V4 of magnitude equal to or greater than a predetermined voltage is applied between the Vcc pin 418 and the GND pin 416, a control power source 42 generates reference voltages V5 and V6, thereby enabling operation of parts in the integrated circuit 41 for control.

In this embodiment, there is provided the control power circuit 5 in which a capacitor C5 and a Zener diode ZD1 are connected in parallel to each other. A Zener voltage of the Zener diode ZD1 serves as the control voltage V4. For simplicity of configuration, a high resistor (not shown) is connected between a positive electrode of the capacitor C3 and a positive electrode of the capacitor C5, and the rectified voltage V2 outputted from the rectifying and smoothing circuit 22 is inputted to the control power circuit 5.

When the control voltage V4 is applied to the integrated circuit 41 for control, firstly, a starter 44 outputs a start pulse to a set input terminal (S terminal) 451 of a flip-flop 45 via an OR gate 46. Accordingly, an output level of an output terminal (Q terminal) 452 of the flip-flop 45 becomes a high level. Further, an output level of the GD pin 417 also becomes a high level via a driving circuit 47.

A series circuit of resistors R2 and R3 is connected between the GD pin 417 and the ground, and a connection point between the resistors R2 and R3 is connected to a gate of the switching device Q1. When the output level of the GD pin 417 becomes a high level, a voltage divided by the resistors R2 and R3 is applied between a gate and a source of the switching device Q1, thereby turning on the switching device Q1. Further, since the resistor R1 has a small resistance used in current detection, the resistor R1 hardly affects the voltage applied between the gate and the source.

When the switching device Q1 is turned on, the direct current I1 flows through a path of the capacitor C4, the inductor L1, the switching device Q1 and the resistor R1 from the rectifying and smoothing circuit 22. In this case, the direct current I1 flowing in the inductor L1 almost linearly increases unless the inductor L1 is magnetically saturated. Further, the resistor R1 is a detection resistor of the direct current I1 while the switching device Q1 is turned on. A voltage V7 between both terminals of the resistor R1 serves as a detection signal of the direct current I1 and is outputted to the CS pin 414 of the integrated circuit 41 for control.

Further, the voltage V7 inputted to the CS pin 414 is applied to a non-inverting input terminal of a comparator CP1 via a noise filter having a resistor R4 and a capacitor C8. Further, in this embodiment, the resistor R4 is 40 kΩ and the capacitor C8 is 5 pF.

A reference voltage V8 is applied to an inverting input terminal of the comparator CP1. The reference voltage V8 is an output voltage of the multiplier circuit 43 and is determined based on a voltage V9 applied to the INV pin 411 and a voltage V10 applied to the MULT pin 413.

If the direct current I1 flowing in the inductor L1 becomes equal to or greater than a predetermined value and the voltage V7 across the resistor R1 is equal to or greater than the reference voltage V8, the output level of the comparator CP1 becomes a high level, and a signal of a high level is inputted to a reset input terminal (R terminal) 453 of the flip-flop 45. Accordingly, the output level of the output terminal (Q terminal) 452 of the flip-flop 45 becomes a low level.

When the output level of the output terminal (Q terminal) 452 of the flip-flop 45 becomes a low level, an output level of the driving circuit 47 becomes a low level, and a current flows into the integrated circuit 41 from the GD pin 417. A series circuit of a diode D2 and a resistor R5 is connected in parallel to the resistor R2. The driving circuit 47 immediately turns off the switching device Q1 by pulling charges between the gate and the source of the switching device Q1 via the diode D2 and the resistor R5.

When the switching device Q1 is turned off, a regenerative current flows via the diode D1 based on the electromagnetic energy accumulated in the inductor L1 and the capacitor C4 discharges. Herein, a voltage across the inductor L1 is clamped to the voltage V3 between both terminals of the capacitor C4. If the inductor L1 has an inductance L1a, the regenerative current flowing in the inductor L1 decreases with an almost constant gradient (di/dt≈V3/L1a)

If the voltage V3 across the capacitor C4 is high, the regenerative current rapidly decreases. If the capacitor voltage V3 is low, the regenerative current gradually decreases. That is, although a peak value of the regenerative current flowing in the inductor L1 is constant, the time required until the regenerative current vanishes varies depending on a load voltage. The time required becomes short as the capacitor voltage V3 is high, and becomes long as the capacitor voltage V3 is low.

Further, while the regenerative current flows, a secondary voltage V11 is generated between both terminals of a secondary coil L11 of the inductor L1 and decreases with the gradient of the regenerative current. The secondary voltage V11 is outputted to a ZCD pin 415 as a detection signal of the regenerative current via a resistor R6. The secondary voltage V11 becomes zero as the regenerative current becomes zero.

An inverting input terminal of a comparator CP2 for zero-cross detection is connected to the ZCD pin 415. Further, the reference voltage V6 is applied to a non-inverting input terminal of the comparator CP2. Further, when the regenerative current decreases and the secondary voltage V11 is equal to or smaller than the reference voltage V6, the output level of the comparator CP2 becomes a high level.

Accordingly, a signal of a high level is outputted to the set input terminal (S terminal) 451 of the flip-flop 45 via the OR gate 46. Further, the output level of the output terminal (Q terminal) 452 of the flip-flop 45 becomes a high level, and the output level of the GD pin 417 becomes a high level, thereby turning on the switching device Q1.

As described above, the switching device Q1 is turned on/off by repeating the above operation, and the capacitor voltage V3 stepped down from the rectified voltage V2 is generated between both terminals of the capacitor C4. Thus, the LED current I2 supplied to the light source 6 is controlled to be a constant current. Further, the light source 6 includes a plurality of LED elements 61 connected to each other in series. If a forward voltage of the LED elements 61 is Vf and the number of LED elements 61 connected in series to each other is n, the capacitor voltage V3 is almost clamped to Vf×n.

Next, dimming control of the light source 6 will be described.

In the lighting device of this embodiment, a high frequency chopper operation intermittently stops in accordance with a low frequency PWM signal S1 transmitted from, e.g., a dimmer (not shown). Accordingly, the LED current I2 is supplied to the light source 6 based on the duty of the PWM signal S1, thereby dimming the light source.

A switching device Q2 including an n-channel MOSFET is connected between the ground and a gate terminal of the switching device Q1. The PWM signal S1 is inputted to a gate terminal of the switching device Q2.

The PWM signal S1 is a square wave voltage signal having a PWM frequency which is a low frequency ranging from, e.g., about 100 Hz to 2 kHz. The PWM signal S1 is configured such that a brightness level increases as a low level period in one cycle is long. This type of the PWM signal S1 is widely used in a lighting device for illumination such as a fluorescence lamp.

When the PWM signal S1 is at a high level, the switching device Q2 is turned on. Accordingly, the gate terminal of the switching device Q1 is connected to the ground. That is, while the PWM signal S1 is at a high level, an off state of the switching device Q1 is maintained regardless of the output level of the GD pin 417, and a chopper operation (switching operation of the switching device Q1) stops.

While the chopper operation stops, the direct current I1 is not supplied from the rectifying and smoothing circuit to the capacitor C4. Accordingly, the capacitor C4 discharges and the capacitor voltage V3 decreases.

When the PWM signal S1 is at a low level, the switching device Q2 is turned off (in a high impedance state). That is, when the PWM signal S1 is at a low level, a normal chopper operation for turning on/off the switching device Q1 is performed in accordance with the output level of the GD pin 417. During a chopper operation, the switching device Q1 is turned on/off, and the capacitor voltage V3 is generated between both terminals of the capacitor C4, thereby supplying the light source 6 with the LED current I2.

Accordingly, a ratio of the chopper operation period to the chopper non-operation period coincides with a ratio (duty ratio) of the low level period to the high level period of the PWM signal S1. During the chopper operation period T1, since the capacitor voltage V3 increases, the LED current I2 increases. During the chopper non-operation period T2, since the capacitor voltage V3 decreases, the LED current I2 decreases. Thus, the LED current I2 depending on a ratio of a low level period to one cycle T0 of the PWM signal S1 is supplied to the light source 6. This makes it possible to perform dimming control (PWM dimming control) of the light source 6 by varying a duty ratio of the PWM signal S1.

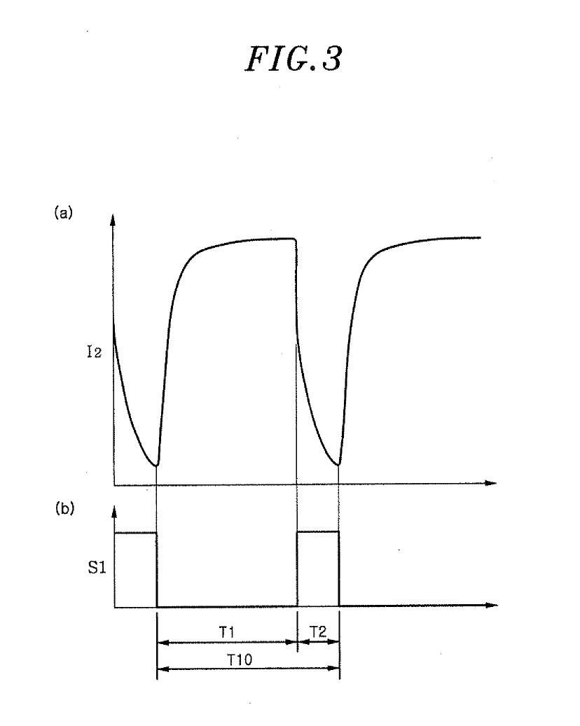

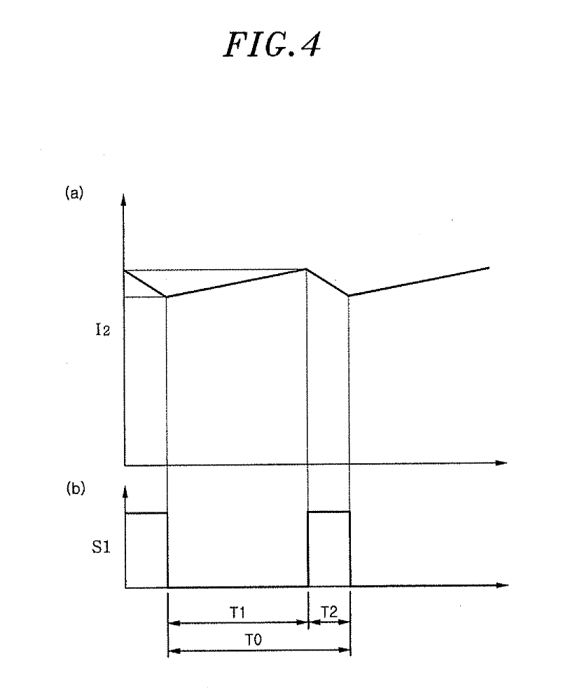

Further, if the PWM frequency is constant, the ripple of the LED current I2 supplied to the light source 6 is determined by the capacitance of the capacitor C4. As illustrated in FIG. 3, if the capacitance of the capacitor C4 is small, the LED current I2 during the chopper non-operation period T2 rapidly decreases. On the other hand, if the capacitance of the capacitor C4 is large as shown in FIG. 4, the LED current I2 slowly decreases even in the chopper non-operation period T2, and the ripple of the LED current I2 becomes small.

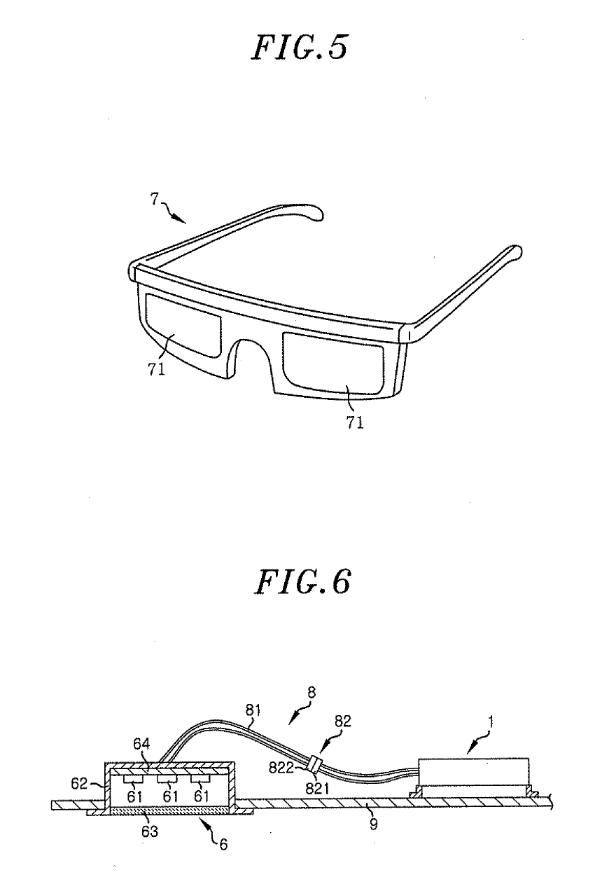

FIG. 5 illustrates a schematic configuration of 3D glasses 7.

The three-dimensional (3D) glasses 7 are used together with an apparatus for displaying a 3D image (stereoscopic image), e.g., a 3D television or the like. A user can wear the 3D glasses to watch a three-dimensional image. The 3D glasses 7 of this embodiment can be used for a 3D image of a frame sequential method and includes a pair of lenses 71 for right and left eyes. Each of the lenses 71 includes a shutter which blocks a translucent surface to obstruct the user's field of vision.

When an image for the left eye is displayed in the 3D television, the shutter of the lens 71 for the right eye is closed to obstruct the right vision. On the other hand, when an image for the right eye is displayed in the 3D television, the shutter of the lens 71 for the left eye is closed to obstruct the left vision. In this way, it is possible to make the user perceive the depth and dimensionality of the image by synchronizing a timing of converting a frame of the 3D image with a timing of alternately opening and closing the left and right shutters of the 3D glasses 7 by using an infrared signal or the like.

A shutter speed (shutter frequency) at which the shutters of the lenses 71 of the 3D glasses 7 are opened and closed is different depending on the types or regions. For example, the shutter speed is 25 Hz in Europe, 30 Hz in the United States, and 60 Hz in Japan.

In case of using the lighting device 1 of this embodiment in a space together with the 3D glasses 7, a PWM frequency is of 300 Hz, which is the least common multiple of the above-mentioned three types of shutter speeds (25 Hz, 30 Hz and 60 Hz). Since an integer multiple of each shutter speed coincides with the PWM frequency, it is possible to prevent a flicker even when the user puts on any one of a plurality of pairs of 3D glasses 7 having different shutter speeds.

Further, the same effect can be obtained by setting the PWM frequency to be an integer multiple (600 Hz, 900 Hz, 1200 Hz, . . . ) of the least common multiple (300 Hz) of the shutter speeds. Since noise occurs in the inductor L1 as the PWM frequency increases, it is preferable that the PWM frequency is low.

The lighting device of this embodiment may be used for a plurality of pairs of 3D glasses 7 having different shutter speeds. With this embodiment, the lighting device can be commonly used without need to individually set the PWM frequency for each type or region, thereby reducing the cost.

Further, it has been found from experimental results that a flicker when putting on the 3D glasses can be further reduced by setting the PWM frequency to be an even multiple (600 Hz, 1200 Hz, . . . ) of the least common multiple (300 Hz). This is because the number of flashes of the light source 6 is equal on the left and right sides while the shutter is opened.

Further, the shutter speed is not restricted to the above values (25 Hz, 30 Hz and 60 Hz) and may have another one. The same effect can be obtained by setting the PWM frequency to be an integer multiple of the least common multiple of a plurality of shutter speeds.

Further, as shown by a dotted line in FIG. 1, the lighting device may include a timing synchronization unit 49 which synchronizes a timing of starting or stopping the chopper operation with a timing of opening/closing the shutters of the 3D glasses 7. For example, when the lighting device of this embodiment is used as a lighting device for turning on the light source 6 cooperating with the 3D television, the timing synchronization unit 49 receives an infrared signal indicating a timing of opening/closing the shutters of the 3D glasses 7 transmitted from the 3D television.

Further, the timing synchronization unit 49 determines a timing of starting or stopping the chopper operation based on the received infrared signal. Thus, it is possible to coincide a timing of starting or stopping the chopper operation with a timing of opening/closing the shutters of the 3D glasses 7, thereby further reducing a flicker when the user puts on the 3D glasses 7.

In the above embodiment, the control power circuit 5 of this embodiment generates the control voltage V4 using the rectified voltage V2. However, the control voltage V4 may be obtained by using the secondary voltage V11 generated between both terminals of the secondary coil L11 of the inductor L1. It is possible to improve power efficiency by using the secondary voltage V11 to charge the capacitor C5 in the chopper operation.

In this embodiment, a timing when the regenerative current flowing in the inductor L1 becomes almost zero is detected by detecting the secondary voltage V11 between both terminals of the secondary coil L11 of the inductor L1. However, it is not limited thereto. For example, a timing when the regenerative current vanishes may be detected by a method of detecting an increase in a backward voltage of the diode D1, or a method of detecting a drop in a voltage between drain and source of the switching device Q1.

Further, although only PWM dimming control for PWM controlling the direct current I1 is performed in this embodiment, the same effect can be obtained even when combining amplitude dimming for controlling the amplitude of the direct current I1 with the PWM dimming. In this embodiment, it is possible to control the current flowing in the switching device Q1 by changing the voltages V9 and V10 applied to the INV pin 411 and the MULT pin 413 of the integrated circuit 41 for control, thereby controlling the amplitude of the direct current I1 and performing the amplitude dimming control.

Further, in the circuit configuration of the integrated circuit 41 for control shown in FIG. 2, a disabler 48 stops the driving circuit 47 when a predetermined voltage is inputted to the ZCD pin 415.

### Second Embodiment

An illumination apparatus 8 in accordance with a second embodiment of the present invention includes the light source 6 and the lighting device 1 of the first embodiment. FIG. 6 illustrates a schematic cross-sectional view of the illumination apparatus 8.

In the illumination apparatus 8 of this embodiment, the light source 6 and the lighting device 1 serving as a power source unit are separately provided and electrically connected to each other by using lead wires 81. By separately providing the lighting device 1 and the light source 6, the light source 6 can become thinner. Further, a degree of freedom in an installation place of the lighting device 1 is improved.

The light source 6 is an LED module having the LED elements 61, a housing 62, a light diffusion plate 63 and a mounting substrate 64. The light source 6 is buried in a ceiling 9 from which a surface of the light source 6 is exposed.

The housing 62 is formed of a cylindrical metal body with one surface opened, and the opening of the housing 62 is covered with the light diffusion plate 63. Further, the mounting substrate 64 is installed at a bottom surface of the housing 62 facing the light diffusion plate 63. Further, a plurality of LED elements 61 is mounted on one surface of the mounting substrate 64, and light from the LED elements is diffused by the light diffusion plate 63 and illuminated toward the floor.

Since the lighting device 1 is provided separately from the light source 6, the lighting device 1 can be installed at a position separated from the light source 6. In this embodiment, the lighting device 1 is installed at a backside of the ceiling 9. Further, the output of the step-down chopper circuit 3 of the lighting device 1 is applied to the light source 6 via the lead wires 81 and a connector 82, so that the LED current I2 is supplied to the light source 6. The connector 82 includes a connector 821 for the lighting device 1 and a connector 822 for the light source 6 which are detachable. Further, the lighting device 1 and the light source 6 can be detached from each other in maintenance.

Since the illumination apparatus 8 of this embodiment includes the lighting device 1 of the first embodiment, it can be used for a plurality of pairs of 3D glasses 7 having different shutter speeds. This makes it possible to prevent a flicker when the user puts on the 3D glasses 7.

Further, although the lighting device 1 and the light source 6 are separately provided in this embodiment, the lighting device 1 and the light source 6 may be formed integrally with each other.

While the invention has been shown and described with respect to the embodiments, it will be understood by those skilled in the art that various changes and modification may be made without departing from the scope of the invention as defined in the following claims.

What is claimed is:

1. A lighting device usable in a space together with 3D glasses having shutters which alternately block respective translucent surfaces of a pair of lenses at one of a plurality of shutter frequencies, comprising:
a lighting unit which outputs a direct current to a light source; and
a dimming control unit which turns on/off supply of the direct current to the light source at a predetermined PWM frequency,
wherein the PWM frequency is an integer multiple of the least common multiple of the plurality of shutter frequencies.

2. The lighting device of claim 1, wherein the PWM frequency is an even multiple of the least common multiple.

3. The lighting device of claim 1, further comprising a timing synchronization unit which synchronizes a timing of turning on/off the supply of the direct current to the light source with a timing of opening/closing the shutters of the lenses of the 3D glasses.

4. The lighting device of claim 2, further comprising a timing synchronization unit which synchronizes a timing of turning on/off the supply of the direct current to the light source with a timing of opening/closing the shutters of the lenses of the 3D glasses.

5. An illumination apparatus comprising: the lighting device set forth in claim 1, and a light source which is turned on by the direct current outputted from the lighting device.

6. An illumination apparatus comprising: the lighting device set forth in claim 2, and a light source which is turned on by the direct current outputted from the lighting device.

7. An illumination apparatus comprising: the lighting device set forth in claim 3, and a light source which is turned on by the direct current outputted from the lighting device.

8. An illumination apparatus comprising: the lighting device set forth in claim 4, and a light source which is turned on by the direct current outputted from the lighting device.
